(19) United States
(12) Patent Application Publication
(10) Pub. No.: US 2023/0241580 A1
(43) Pub. Date: Aug. 3, 2023

(54) Absorbent Material

(71) Applicants: Henry Aldorf, Singapore (SG); Matthew Leslie Sutcliffe, Kerikeri (NZ); Pelleton Global Renewables Ltd., Road Town, Tortola (VG)

(72) Inventors: Henry Aldorf, Singapore (SG); Matthew Leslie Sutcliffe, Kerikeri (NZ); John Webster, St. Lucia (AU)

(21) Appl. No.: 17/904,246

(22) PCT Filed: Feb. 12, 2021
(86) PCT No.: PCT/NZ2021/050017

§ 371 Date: Aug. 15, 2022

(30) Foreign Application Priority Data
Feb. 14, 2020 (AU) 2020900430

(51) Int. Cl. B01J 20/24; B01J 20/26; B01J 20/28; B01J 20/30; C02F 1/28

(52) U.S. Cl. CPC B01J 20/24; B01J 20/261; B01J 20/2803; B01J 20/28023; B01J 20/28026; B01J 20/3085; B01J 20/3042; C02F 1/288; C02F 1/286; C02F 2101/36

(57) ABSTRACT

The present invention relates to an absorbent material, the absorbent material comprising: a matrix formed from a fibrous material and one or more polymerised binder reagents. The present invention further relates to a method for producing an absorbent material, the method comprising the steps of: combining a feedstock comprising fibrous material with one or more binder reagents; and introducing the feedstock into an agglomeration apparatus in the presence of a polymerisation activator to produce the absorbent material.

### CROSS-REFERENCE TO RELATED APPLICATIONS

This application is a U.S. national phase patent application of PCT International Patent Application No. PCT/NZ2021/050017, filed on Feb. 12, 2021, which claims the benefit of and priority to New Zealand Application No. 2020900430, filed on Feb. 14, 2020, the contents of each of which are incorporated herein by reference in their entireties.

### TECHNICAL FIELD

The present invention relates to an absorbent material. More specifically, the absorbent material of the present invention is suited to the absorption of liquid wastes. The present invention further relates to a method to produce an absorbent material. The present invention still further relates to a method of absorbing a liquid using the absorbent material.

### BACKGROUND ART

The following discussion of the background art is intended to facilitate an understanding of the present invention only. The discussion is not an acknowledgement or admission that any of the material referred to is or was part of the common general knowledge as at the priority date of the application.

Many industrial processes generate wastes or other materials that may inadvertently be released into the environment. In many cases, these materials can be toxic or otherwise hazardous to both humans and the environment. The scale of these waste releases also varies greatly, ranging from oil spills that release hundreds of millions of litres of oil into the ocean, through to the release of toxic contaminants into waterways at concentrations measured in parts per million. Regardless of the scale, there remains a need to find solutions that will quickly and effectively clean-up these materials from the environment.

Most prior art processes for the clean-up of liquid spills rely on an absorbent material to soak up the spilt liquid. Typical materials used include plant-based materials, such as wood chips or saw dust, or mineral products, such as charcoal or talc. Such materials typically have a low liquid absorption capacity and so large volumes are required. A number of alternative absorbents have been engineered to have a higher liquid absorption capacity, but these materials are often quite expensive to produce. The cost of these materials will often be prohibitive when the scale of the contamination is large, such as for example in an oil spill or large waterway.

The absorption of the liquid waste or contaminated liquids provides only part of the solution. The loaded absorbent material must then be removed from the contamination site to dispose of the absorbed liquid. The main difficulty faced with the removal of most absorbent materials is that the structural integrity of such materials will often degrade once loaded with a liquid. This not only increases the difficulty of separating the loaded absorbent material from the contamination site, but also increases the difficulty in transporting the loaded material away from the site. This problem is particularly prevalent in absorbent materials that are formed from fibrous webs. The fibres of such materials will typically separate when wet and the material will break apart.

A further problem faced with the removal of contaminants from the environment is water content. Absorbent materials will typically not provide any selectivity for particular contaminants over water and so both are typically absorbed into the material. In order to separate the contaminants from the water, the loaded absorbent material will typically need to be subjected to expensive multi-stage dewatering and purification processes to produce clean water suitable for safe disposal or re-use. Such processes could include thickening, flocculation, evaporation drying, centrifugation, precipitation or heating. These processes require intensive energy and chemical expenditure generally greater than the economic return from the products. This results in the loaded absorbent typically being disposed of in landfill increasing the danger of recontamination at the disposal site.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with a first aspect of the present invention, there is provided an absorbent material, the absorbent material comprising:
a matrix formed from a fibrous material and one or more polymerised binder reagents.

Preferably, the absorbent material of present invention is adapted to absorb liquids. More preferably, the absorbent material of present invention is adapted to absorb liquids and one or more substances contained therein.

The inventors have found that the absorbent material of the present invention may be adapted to absorb and/or adsorb various liquids within the matrix. The loaded absorbent may then be transported together with the absorbed liquid. Importantly, the inventors have found that the matrix maintains its structural integrity following liquid absorption. Without wishing to be bound by theory, the inventors believe that the polymerised binder reagents will maintain the structural integrity of the matrix. The absorbent material of the present invention is therefore well suited for the cleanup of liquid spills. Furthermore, the inventors have found that small particles and other dissolved substances contained in the liquid may also be adsorbed into the matrix. In certain circumstances, these substances will be retained within the matrix even after the liquid is removed, typically through evaporation. It is envisaged that the absorbent material of the present invention may be suitable for the capture and removal of unwanted substances from liquids. The composition of the absorbent material can be tailored to the absorption of differing liquids and applications.

Throughout this specification, unless the context requires otherwise, the term ‘polymerised binder reagent’ will be understood to refer to a binder reagent molecule that has undergone polymerisation and/or cross-linking with one or more other binder reagent molecules. The binder reagents may comprise one or more monomers that polymerise or co-polymerise to form a polymerised binder reagent. Alternatively or additionally, the binder reagents may comprise one or more polymers that cross-link to form a polymerised binder reagent. As would be appreciated by a person skilled in the art, polymerisation is a process of combining two or more reactant molecules together in a chemical reaction to form polymer chains. As would be appreciated by a person skilled in the art, the term cross-linking refers to the linking of polymer chains to one another by either covalent bonding or sequences of chemical bonds. In one form of the present invention, the one or more binder reagents comprise binder reagent molecules that are able to polymerise or cross-link upon external activation by, for example, heat, pressure, change in pH or irradiation. In one form of the present invention, the one or more binder reagents comprise binder reagent molecules that are able to polymerise or cross-link upon contact with a polymerisation activator. More preferably, the one or more binder reagents comprise a reagent that is able to polymerise or cross-link in the absence of catalysts or external heat.

In one form of the present invention, the absorbent material comprises 0.05-5 dry weight % polymerised binder reagents. In one form of the present invention, the absorbent material comprises 0.05-4 dry weight % polymerised binder reagents. In one form of the present invention, the absorbent material comprises 0.05-3 dry weight % polymerised binder reagents. In one form of the present invention, the absorbent material comprises 0.05-2 dry weight % polymerised binder reagents. In one form of the present invention, the absorbent material comprises 0.05-1 dry weight % polymerised binder reagents. The amount of the one or more polymerised binder reagents included in the absorbent is dependent on the fibrous material used. In one from of the present invention, the absorbent material comprises 0.05-0.5 dry weight % polymerised binder reagents. The inventors have found that relatively low concentration of the one or more polymerised binder reagents in the absorbent material will be sufficient to maintain the structural integrity of the absorbent material, whilst still permitting sufficient absorptive capacity. Without wishing to be bound by theory, the inventors believe that higher concentrations of polymerised binding reagents will decrease the exposed surface area of the absorbent material. Furthermore, as the polymerised binding reagents are typically the most expensive component of the absorbent material, production costs are lower.

In one form of the present invention, the absorbent material is formed into agglomerates. The IUPAC Compendium of Chemical Terminology, 2nd ed. (the “Gold Book”) defines agglomeration as the process in which dispersed molecules or particles assemble rather than remain as isolated single molecules or particles. Throughout this specification, unless the context requires otherwise, the term “agglomerate” or variations of such, will be understood to refer to an assemblage of discrete particles that are adhered together such that they behave as a single larger particle.

In one form of the present invention, the absorbent material is formed into pellets.

Throughout this specification, unless the context requires otherwise, the term “fibrous material” will be understood to refer to material comprising a multiplicity of fibres. Fibrous materials include cellulosic fibers, synthetic fibers, and combinations thereof. Fibrous materials further include woven materials and nonwoven materials that contain fibers, such as clothing or textile fabrics.

In one form of the present invention, the fibrous material comprises cellulosic fibres. In one form of the present invention, the cellulosic fibres are derived from natural sources, such as from the bark, wood or leaves of plants, or from other plant-based material. Alternatively, cellulosic fibres may be manufactured. As would be appreciated by a person skilled in the art, cellulosic fibres are fibres made with ethers or esters of cellulose. Preferably, the cellulosic fibres have been at least partially delignified. As would be appreciated by person skilled in the art, delignification will either physically or chemically separate cellulosic fibres. In one form of the present invention, the fibrous material comprises one or more of wood fibers, pulp fibers, cotton fibers, hemp fibers, silk fibers, rayon fibers and lyocell fibers.

In an alternative form of the present invention, the fibrous material comprises synthetic fibres. In one form of the present invention, the fibrous material comprises one or more of polyethylene fibers, polypropylene fibers, polyester fibers and bicomponent fibers.

In one form of the present invention, the absorbent material comprises 10-99.5 weight % fibrous material. Preferably, the absorbent material comprises 30-60 weight % fibrous material.

In one embodiment, at least 90% of the fibrous material has a fibre length between 5 and 500 μm.

In one embodiment, at least 90% of the fibrous material has a fibre thickness of 0.3 μm to 50 μm.

In one form of the present invention, the absorbent material comprises a reinforcing filler. Preferably, the reinforcing filler is dispersed throughout the fibrous matrix. Preferably, the reinforcing filler is solid. In one form of the present invention, the reinforcing filler is particulate. The inventors have found that the inclusion of particulate fillers in the absorbent material can provide increased strength to the absorbent material. This assists the absorbent material in maintaining its shape and structural integrity during handling and transport.

The reinforcing filler may comprise an organic filler, an inorganic filler, or both. In one form of the present invention, the reinforcing filler is selected from one or more of saw dust, clays, calcium carbonate, silicates, activated carbon, starches, glass microspheres.

Preferably, the reinforcing filler is insoluble.

In one embodiment, the average particle size of the reinforcing filler is 10 μm-400 μm.

In one embodiment, the absorbent material comprises 0-80 dry weight % reinforcing fillers. In one embodiment, the absorbent material comprises 40-70 dry weight % reinforcing fillers.

In one form of the present invention, the absorbent material is formed into agglomerates. Preferably, the diameter of the agglomerates is between 4 mm and 300 mm. As would be appreciated by a person skilled in the art, the size of the produced agglomerates may be tailored to suit the specific use of the absorbent material.

In one form of the present invention, the water content of the dry absorbent material is less than 20 weight %. Preferably, the water content of the dry absorbent material is less than 15 weight %. More preferably, the water content of the dry absorbent material is less than 10 weight %. More preferably, the water content of the dry absorbent material is less than 5 weight %.

In one form of the present invention, the absorbent material has a bulk density of 200 kg/m³ to 1.5 t/m³.

In one form of the present invention, the absorbent material has a liquid absorbing capacity of at least 1.5 times the dry weight. In one form of the present invention, the liquid absorbing capacity is at least 2 times the dry weight. In one form of the present invention, the liquid absorbing capacity is at least 2.5 times the dry weight.

In one form of the present invention, the absorbent material has a water absorbing capacity of at least 1.5 times the dry weight. In one form of the present invention, the water absorbing capacity is at least 2 times the dry weight. In one form of the present invention, the water absorbing capacity is at least 2.5 times the dry weight.

In one form of the present invention, the absorbent material has a porosity of at least 0.60. Preferably, the porosity is measured using the water evaporation method where porosity=(weight of saturated sample−weight of dried sample)/density of water).

In one form of the present invention, the absorbent material further comprises one or more additives. The inventors have found that the inclusion of additives materials into the matrix can be used to provide additional physical properties to the absorbent material.

In one embodiment, the additives include active adsorption agents. It is envisaged that the inclusion of active adsorption agents into the absorbent material will allow the absorbent material to selectively adsorb particular target substances. In one embodiment, the absorbent material comprises between 0% and 80% active adsorption agents. As would be appreciated by a person skilled in the art, the amount of active adsorption agent included in the absorbent material can be tailored to suite the specific application of the absorbent material. In applications where the liquid comprises a low concentration of target substances, a larger volume of active adsorption agents in the absorbent material will allow for the adsorption of more target substances. This has been found to allow the absorbent material to be dewatered and reused multiple times before the active adsorption agents are fully loaded.

In one embodiment, the additives include neutralisation agents. In one embodiment, the absorbent material comprises between 0% and 50% neutralisation agents.

In one form of the present invention, the absorbent material is suitable for use as combustible fuel source.

In accordance with a second aspect of the present invention, there is provided a method for producing an absorbent material, the method comprising the steps of:
combining a feedstock comprising fibrous material with one or more binder reagents, and
introducing the feedstock into an agglomeration apparatus in the presence of a polymerisation activator to produce the absorbent material.

In one form of the present invention, the fibrous material comprises cellulosic fibres. As would be appreciated by a person skilled in the art, cellulosic fibres are fibres made with ethers or esters of cellulose. The fibres may also contain hemicellulose and lignin. In one form of the present invention, the cellulosic fibres are derived from natural sources, such as from the bark, wood or leaves of plants, or from other plant-based material. Alternatively, cellulosic fibres may be manufactured. In one form of the present invention, the fibrous material comprises one or more of wood fibers, pulp fibers, cotton fibers, hemp fibers, silk fibers, rayon fibers and lyocell fibers

In an alternative form of the present invention, the fibrous material comprises synthetic fibres. In one form of the present invention, the fibrous material comprises one or more of polyethylene fibers, polypropylene fibers, polyester fibers and bicomponent fibers.

In one form of the present invention, the absorbent material is formed into agglomerates.

Preferably, the absorbent material of present invention is adapted to absorb liquids. More preferably, the absorbent material of present invention is adapted to absorb liquids and one or more materials entrained or dissolved therein.

It is understood by the inventors that the polymerisation activator will initiate polymerisation and/or crosslinking of the one or more binder reagents. The polymerised binder reagents will combine with the fibrous material to produce a matrix. This matrix will separate out into discrete agglomerates of the absorbent material of the present invention.

In a preferred form of the invention, the step of combining the feedstock with the one or more binder reagents occurs prior to the step of introducing the feedstock into an agglomeration apparatus to produce the agglomerates, such that the method comprises the steps of:
combining the feedstock with one or more binder reagents to produce an agglomeration mixture; then
introducing the agglomeration mixture into an agglomeration apparatus in the presence of a polymerisation activator to produce the agglomerates.

In one form of the present invention, the polymerisation activator is contacted with the feedstock and the one or more binder reagents prior to the step of introducing the feedstock into an agglomeration apparatus to produce the agglomerates.

In a preferred form of the present invention, the polymerisation activator is contacted with the feedstock and the one or more binder reagents simultaneous to, or after the feedstock is introduced into the agglomeration apparatus.

The step of combining the feedstock with one or more binder reagents to produce an agglomeration mixture is carried out in a suitable mixing apparatus. Preferably, the agglomeration mixtures is substantially homogenous.

In one form of the present invention, the diameter of the produced agglomerates is between 4 mm and 300 mm.

In one form of the present invention, the method further comprises the step of:

drying the agglomerates.

In one form of the present invention, the agglomeration mixture comprises between 10-99.5 weight % fibrous material.

In one form of the present invention, the agglomeration mixture comprises between 0.05% to 5% weight % binder reagents.

In one embodiment, the water content of the agglomeration mixture is between 40% and 80%.

In one embodiment, the agglomeration mixture further comprises a reinforcement filler. Preferably, the agglomeration mixture comprises between 0 and 50% of the reinforcement filler.

In one embodiment, the agglomeration mixture further comprises one or more additives.

In one form of the present invention the quantity of the polymerisation activator is 0.005% to 0.5% by dry weight of the agglomeration mixture.

In one form of the present invention, the one or more binder reagents comprise a reagent that is able to polymerise, cross-link or form a stiff gel. Preferably, the one or more binder reagents comprise a reagent that is able to polymerise, cross-link upon contact with the polymerisation activator. More preferably, the one or more binder reagents comprise a reagent that is able to polymerise, cross-link or form a stiff gel in air but in the absence of catalysts or external heat.

Preferably, the one or more binder reagents are combined with the feedstock prior to the addition of the polymerisation activator. Preferably the combination of the one or more binder reagents and the polymerization activator produces as substantially homogenous agglomeration mixture.

In one form of the present invention, the method further comprises the step of:

pre-treatment of the feedstock.

In one form of the present invention, the step of pre-treatment of the feedstock occurs prior to the step of combining the feedstock with one or more binder reagents. Preferably, the pre-treatment of the feedstock comprises one or more of screening, size reduction, fibre softening and fibre separation.

In accordance with a third aspect of the present invention, there is provided an absorbent material formed by the process of the second aspect of the present invention.

In accordance with a fourth aspect of the present invention, there is provided a method of absorbing a liquid, the method comprising the step of contacting the liquid with the absorbent material described above to absorb at least a portion of the liquid into the absorbent material to produce a loaded absorbent material.

In one form of the present invention, at least a portion of entrained particles or dissolved substances within the liquid will be absorbed by the absorbent material.

In one form of the present invention, at least a portion of entrained particles or dissolved substances within the liquid will be adsorbed by the absorbent material.

In one form of the present invention, the loaded absorbent material may be directed to one or more treatment steps.

In one form of the present invention, the one or more treatment steps comprise the recovery of the absorbed liquids.

In one form of the present invention, the one or more treatment steps comprise the chemical treatment of the loaded absorbent material. Preferably, the chemical treatment will be used to deactivate or neutralise the loaded material.

In one form of the present invention, the loaded absorbent material is subjected to a drying step. In one form of the present invention, the drying step comprises the evaporation of water and other volatile compounds from the loaded absorbent material. Preferably, an airflow is directed across the surface of the absorbent material.

In one form of the present invention, the drying step comprises the removal of at least a portion of the liquid from the loaded absorbent material. In one form of the present invention, following the step of removal of at least a portion of the liquid from the loaded absorbent material, the absorbent material may again be used to absorb more liquid.

As discussed above, the absorbent material of the present invention may absorb substances entrained in the absorbed material. This has been found by the inventors to be particularly useful in cleaning up contaminants in water sources. It has been found that when the absorbed water is removed in the drying stage, at least some of the co-absorbed/adsorbed substances will be retained in the matrix.

In one form of the present invention, the loaded absorbent material may be directed to disposal.

In one form of the present invention, the loaded absorbent material may be subjected to a high temperature treatment step to destroy combustible materials. Furthermore, non-combustible materials can be recovered and disposed of.

In one form of the present invention, the loaded absorbent may be used as a combustible fuel source.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a process for the production of an absorbent material from a feedstock that comprises a fibrous material in accordance with a second aspect of the present invention.

### DESCRIPTION OF EMBODIMENTS

As described above, in one aspect of the present invention there is provided an absorbent material, the absorbent material comprising a porous matrix formed from a fibrous material and one or more polymerised binder reagents.

### Fibrous Material

The term “fibrous material” may mean one fibre type or may encompass two or more fibre types.

In one form of the present invention, the fibrous material comprises cellulosic fibres. As would be appreciated by a person skilled in the art, cellulosic fibres are fibres made with ethers or esters of cellulose. The fibres may also contain hemicellulose and lignin. Such cellulosic fibres may be obtained from natural sources. Alternatively, cellulosic fibres may be manufactured.

The cellulosic fibre may be virgin fibre, reclaimed fibre, recycled fibre, or combinations of these. Suitable cellulosic fibres may be selected from, but not limited to the following: paper, paper wastes, wood, wood wastes, sawdust, bark & forestry waste, agricultural waste, compost & non-recyclables, wine/brewery waste, fruit waste, olive waste, vegetable oil waste, food wastes, biomass, cellulosic lignin, bagasse, cane trash, corn stover and green wastes.

In an alternative form of the present invention, the fibrous material comprises synthetic fibres. Synthetic fibres are typically created by extruding fibre-forming materials through spinnerets. Such fibre forming materials are typically polymerised monomer materials. In particular, the synthetic fibres are thermoplastic polymer fibres, such as polylactide, glycolic acid polymer, polyolefin, polyethylene terephthalate, polyester, polyamide, polyvinyl alcohol or bicomponent (bico) fibres. Examples of other fibres are regenerated cellulose fibres such as viscose, lyocell, rayon, and Tencel® fibres, and for example, carbon and glass fibres. Most suitably, polyolefin, polyester, polylactide or bico fibres or mixtures thereof, are used.

In one embodiment, at least 90% of the fibrous material fibres have a length between 5 and 500 μm.

In one embodiment, at least 90% of the fibrous material fibres have a mean thickness of 0.3 μm to 50 μm.

In one embodiment, the absorbent material comprises 10-99.5 weight % fibrous material.

### Reinforcing Fillers

In one form of the present invention, the absorbent material comprises a reinforcing filler. Preferably, the reinforcing filler is particulate. The inventors have found that the inclusion of particulate fillers in the porous absorbent can provide increased strength to the absorbent material. This allows for the absorbent material to retain its shape and structural integrity during handling and transport.

Preferably, the reinforcing filler is obtained from a natural source. Suitable natural sources include wood and other plant material that have been ground to a particulate matter. The inventors have found that sawdust is particularly useful as a reinforcing filler.

In one embodiment, the reinforcing filler has an average particle size of at least 10 μm.

In one embodiment, the reinforcing filler has an average particle size between 10 μm and 400 μm.

In one embodiment, the absorbent material comprises between 0% and 50% reinforcing fillers.

### Additives

In one form of the present invention, the absorbent material comprises one or more additives. The choice of additive is highly dependent on the particular liquid to be absorbed and whether other substances or contaminants are present.

In one embodiment, the additives include active adsorption agents to selectively absorb particular target substances. It is envisaged that these agents will generally have a micro-porous structure that will accommodate certain sized species, particularly charged species. Such agents may be selected from one or more of zeolites, pumice type minerals, activated carbon/char, modified active clays and ion exchange resins.

In one embodiment, the active adsorption material is used as a seed particle for the production of the agglomerated absorbent material. It is envisaged that the active adsorption material will form the core of the agglomerate.

In one embodiment, the particle size of the active adsorption material is between 10 μm and 50 mm.

In one embodiment, the absorbent material comprises between 0% and 80% active adsorption agents.

In one embodiment, the additives include neutralisation agents. Such neutralisation agents include pH modifiers, chlorinators, bactericides and odour removal agents. Such neutralisation agent have been found to be useful when treating liquids that are acidic, alkaline, infected or rancid in nature.

In one embodiment, the absorbent material comprises between 0% and 50% neutralisation agents.

### Polymerised Binder Reagents

As discussed above, the term polymerised binder reagent is intended to refer to one or more binder reagents that have undergone polymerisation and/or cross-linking.

In one form of the present invention, the absorbent material comprises 0.05-1 dry weight % polymerised binder reagents. In one form of the present invention, the absorbent material comprises 0.05-0.9 dry weight % polymerised binder reagents. In one form of the present invention, the absorbent material comprises 0.05-0.8 dry weight % polymerised binder reagents. In one form of the present invention, the absorbent material comprises 0.05-0.7 dry weight % polymerised binder reagents. In one form of the present invention, the absorbent material comprises 0.05-0.6 dry weight % polymerised binder reagents. In one form of the present invention, the absorbent material comprises 0.05-0.5 dry weight % polymerised binder reagents. In one form of the present invention, the absorbent material comprises 0.05-0.4 dry weight % polymerised binder reagents. In one form of the present invention, the absorbent material comprises 0.05-0.3 dry weight % polymerised binder reagents.

In one form of the present invention, the absorbent material comprises 0.1-0.9 dry weight % polymerised binder reagents. In one form of the present invention, the absorbent material comprises 0.1-0.8 dry weight % polymerised binder reagents. In one form of the present invention, the absorbent material comprises 0.1-0.7 dry weight % polymerised binder reagents. In one form of the present invention, the absorbent material comprises 0.1-0.6 dry weight % polymerised binder reagents. In one form of the present invention, the absorbent material comprises 0.1-0.5 dry weight % polymerised binder reagents. In one form of the present invention, the absorbent material comprises 0.05-0.5 dry weight % polymerised binder reagents.

In one form of the present invention, the ratio of the fibrous material to the one or more polymerised binder reagents in the absorbent material is between 50:1 and 400:1. In one form of the present invention, the ratio of the fibrous material to the one or more polymerised binder reagents in the absorbent material is between 100:1 and 200:1.

In one form of the present invention, the one or more binder reagents comprise a monomer compound. As would be understood be a person skilled in the art, a monomer compound is a compound that can undergo polymerization thereby contributing constitutional units to the essential structure of a macromolecule. Preferably, the one or more binders are anionic or cationic monomer, optionally with a non-ionic monomer. It may be amphoteric, being formed from a mixture of cationic and anionic monomers, optionally with non-ionic monomer. Suitable anionic monomers are carboxylic acids, aminopolycarboxylic acids or sulphonic acids, often in the form of a water soluble ammonium or, preferably, alkali metal salt. Suitable carboxylic acids are methacrylic, itaconic, maleic or, preferably, acrylic acid. Suitable sulphonic acids include allyl, methallyl, vinyl and 2-acrylamido-2-methyl propane sulphonic acids, often as ammonium, or more usually, alkali metal salt. Suitable cationic monomers include dialkylaminoalkyl (meth)-acrylamides, -acrylates and -vinyl acrylates, usually as acid addition or quaternary ammonium salts, and monomers such as diallyl dimethyl ammonium chloride. Suitable non-ionic monomers include (meth) acrylic esters, methacrylamide andacrylamide.

Preferably, the one or more binder reagents comprise a styrene monomer compound, a vinyl monomer compound or a silicon monomer compound. Preferably, the silicon monomer compound is a silane monomer compound. In one form of the invention, the binder reagent comprises a styrene monomer. In one form of the invention, the binder reagent comprises a silicon monomer.

In one form of the present invention, the one or more binder reagents further comprises a surfactant. More preferably, the surfactant is selected from the group comprising alcohols, carboxylic acid, silane, siloxane or a silonol. It is understood by the inventors that the choice of surfactant is dependant on the end use of the agglomerates and the chemical content of the feedstock, especially the silica level of the biomass and the ash characteristics It is understood by the inventors that the addition of a surfactant allows for the rapid penetration of the one or more binder reagents into the feedstock. Preferably, the amount of the surfactant added is 0.025% to 0.5% by dry weight of the feedstock. In one form of the present invention, the polymerisation activator is a substance which initiates the polymerisation, cross-linking or gel formation of at least one of the one or more binder reagents. Without being bound be theory, the inventors believe that the in-situ polymerisation, cross linking or gel formation of the at least one binder agent as the agglomerates is being formed in the agglomeration apparatus produces a final agglomerate product that can suitably hold a biomass feedstock stream within its matrix.

### Polymerisation Agent

In embodiments of the present invention, a polymerisation activator is used to polymerise or cross-link the one or more binder reagents. In this embodiment, the term polymerised binder reagents will be understood to include the polymerisation activator. In one form of the present invention, the polymerisation activator comprises a monomer cross-linking compound. Preferably, the polymerisation activator is a vinyl, stearic or acrylic monomer crosslinking compound. It is understood that the polymerisation activator acts to polymerise or cross-link with the one or more binder reagents to form a stiff mixture that will form a porous matrix with the feedstock.

In one form of the present invention, the one or more binder reagents may require the addition of an initiator reagent to allow or assist polymerisation. It is understood by the applicant that the initiator reagent can be any chemical species which reacts with the binder reagent monomers to form an intermediate compound capable of linking successively with a large number of other monomers into a polymeric compound. As would be understood by the person skilled din the art, most initiator reagents contain free radicals. In a highly preferred form of the present invention, initiator reagent is either ammonium persulphate (NH₄)S₂O₈ or potassium persulphate K₂S₂O₈ or a combination of both. It is envisaged that the use of ionising radiation such as ultra violet light and the formation of ozone may also be used to activate the polymerisation. It is understood by the inventors that the initiator reagent supplies free radicals to initiate the polymerisation of the selected reagent groups.

### Absorbent Material Properties

In one form of the present invention, the absorbent material has a bulk density of 200 kg/m³ to 1.5 kg/m³.

In one form of the present invention, the absorbent material has a liquid absorbing capacity of at least 0.1 times the dry weight. In one form of the present invention, the absorbent material has a liquid absorbing capacity of at least 0.2 times the dry weight. In one form of the present invention, the absorbent material has a liquid absorbing capacity of at least 0.3 times the dry weight. In one form of the present invention, the absorbent material has a liquid absorbing capacity of at least 0.4 times the dry weight. In one form of the present invention, the absorbent material has a liquid absorbing capacity of at least 0.5 times the dry weight. In one form of the present invention, the absorbent material has a liquid absorbing capacity of at least 0.6 times the dry weight. In one form of the present invention, the absorbent material has a liquid absorbing capacity of at least 0.7 times the dry weight. In one form of the present invention, the absorbent material has a liquid absorbing capacity of at least 0.8 times the dry weight. In one form of the present invention, the absorbent material has a liquid absorbing capacity of at least 0.9 times the dry weight. In one form of the present invention, the absorbent material has a liquid absorbing capacity of at least 1.0 times the dry weight. In one form of the present invention, the absorbent material has a liquid absorbing capacity of at least 1.1 times the dry weight. In one form of the present invention, the absorbent material has a liquid absorbing capacity of at least 1.2 times the dry weight. In one form of the present invention, the absorbent material has a liquid absorbing capacity of at least 1.3 times the dry weight. In one form of the present invention, the absorbent material has a liquid absorbing capacity of at least 1.4 times the dry weight. In one form of the present invention, the absorbent material has a liquid absorbing capacity of at least 1.5 times the dry weight. In one form of the present invention, the absorbent material has a liquid absorbing capacity of at least 1.6 times the dry weight. In one form of the present invention, the absorbent material has a liquid absorbing capacity of at least 1.7 times the dry weight. In one form of the present invention, the absorbent material has a liquid absorbing capacity of at least 1.8 times the dry weight. In one form of the present invention, the absorbent material has a liquid absorbing capacity of at least 1.9 times the dry weight. In one form of the present invention, the liquid absorbing capacity is at least 2 times the dry weight. In one form of the present invention, the absorbent material has a liquid absorbing capacity of at least 2.1 times the dry weight. In one form of the present invention, the absorbent material has a liquid absorbing capacity of at least 2.2 times the dry weight. In one form of the present invention, the absorbent material has a liquid absorbing capacity of at least 2.3 times the dry weight. In one form of the present invention, the absorbent material has a liquid absorbing capacity of at least 2.4 times the dry weight. In one form of the present invention, the liquid absorbing capacity is at least 2.5 times the dry weight.

In one form of the present invention, the absorbent material has a water absorbing capacity of at least 0.1 times the dry weight. In one form of the present invention, the absorbent material has a water absorbing capacity of at least 0.2 times the dry weight. In one form of the present invention, the absorbent material has a water absorbing capacity of at least 0.3 times the dry weight. In one form of the present invention, the absorbent material has a water absorbing capacity of at least 0.4 times the dry weight. In one form of the present invention, the absorbent material has a water absorbing capacity of at least 0.5 times the dry weight. In one form of the present invention, the absorbent material has a water absorbing capacity of at least 0.6 times the dry weight. In one form of the present invention, the absorbent material has a water absorbing capacity of at least 0.7 times the dry weight. In one form of the present invention, the absorbent material has a water absorbing capacity of at least 0.8 times the dry weight. In one form of the present invention, the absorbent material has a water absorbing capacity of at least 0.9 times the dry weight. In one form of the present invention, the absorbent material has a water absorbing capacity of at least 1.0 times the dry weight. In one form of the present invention, the absorbent material has a water absorbing capacity of at least 1.1 times the dry weight. In one form of the present invention, the absorbent material has a water absorbing capacity of at least 1.2 times the dry weight. In one form of the present invention, the absorbent material has a water absorbing capacity of at least 1.3 times the dry weight. In one form of the present invention, the absorbent material has a water absorbing capacity of at least 1.4 times the dry weight. In one form of the present invention, the absorbent material has a water absorbing capacity of at least 1.5 times the dry weight. In one form of the present invention, the absorbent material has a water absorbing capacity of at least 1.6 times the dry weight. In one form of the present invention, the absorbent material has a water absorbing capacity of at least 1.7 times the dry weight. In one form of the present invention, the absorbent material has a water absorbing capacity of at least 1.8 times the dry weight. In one form of the present invention, the absorbent material has a water absorbing capacity of at least 1.9 times the dry weight. In one form of the present invention, the water absorbing capacity is at least 2 times the dry weight. In one form of the present invention, the absorbent material has a water absorbing capacity of at least 2.1 times the dry weight. In one form of the present invention, the absorbent material has a water absorbing capacity of at least 2.2 times the dry weight. In one form of the present invention, the absorbent material has a water absorbing capacity of at least 2.3 times the dry weight. In one form of the present invention, the absorbent material has a water absorbing capacity of at least 2.4 times the dry weight. In one form of the present invention, the water absorbing capacity is at least 2.5 times the dry weight.

In one form of the present invention, the absorbent material has a porosity of at least 0.60. Preferably, the porosity is measured using the water evaporation method where pore volume=(weight of saturated sample−weight of dried sample)/density of water). In one form of the present invention, the absorbent material has a porosity of at least 0.65. In one form of the present invention, the absorbent material has a porosity of at least 0.70. In one form of the present invention, the absorbent material has a porosity of at least 0.75. In one form of the present invention, the absorbent material has a porosity of at least 0.80. In one form of the present invention, the absorbent material has a porosity of at least 0.85. In one form of the present invention, the absorbent material has a porosity of at least 0.9.

Preferably, the water content of the absorbent material is less the 20%. More preferably, the water content of the absorbent material is less than 19%. Still preferably, the water content of the absorbent material is less than 18%. Still preferably, the water content of the absorbent material is less than 17%. Still preferably, the water content of the absorbent material is less than 16%. Still preferably, the water content of the absorbent material is less than 15%. Still preferably, the water content of the absorbent material is less than 14%. Still preferably, the water content of the absorbent material is less than 13%. Still preferably, the water content of the absorbent material is less than 12%. Still preferably, the water content of the absorbent material is less than 11%. Still preferably, the water content of the absorbent material is less than 10%. Still preferably, the water content of the absorbent material is less than 9%. Still preferably, the water content of the absorbent material is less than 8%.

### Absorbent Material Production Process

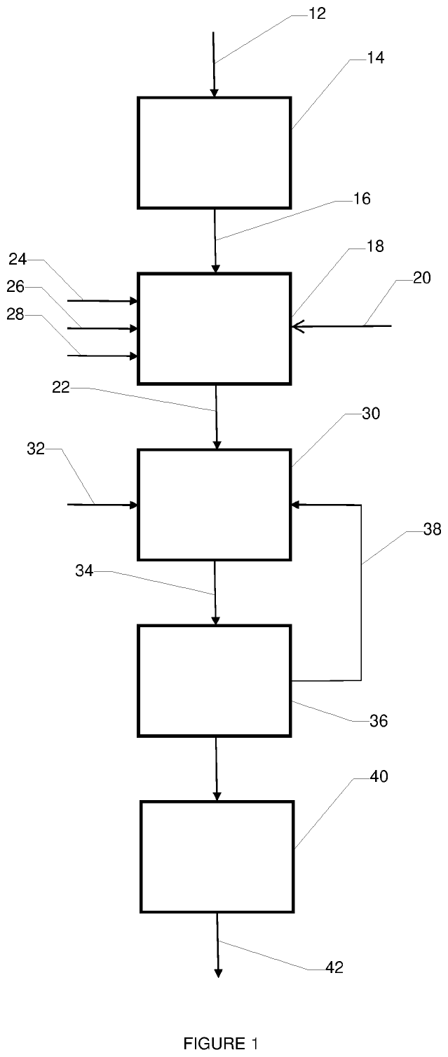

In FIG. 1, there is shown a process for the production of an absorbent material 10 from a feedstock that comprises a fibrous material in accordance with a second aspect of the present invention.

In the embodiment shown in the FIGS. 1, a fibrous material stream 12 is subjected to a pre-treatment step 14. The pre-treatment step 14 prepares the fibrous material stream 12 for the further processing and may contain one or more of the following pre-treatment steps, screening, shredding, grinding and dewatering to produce a fibrous feedstock 16. The required pre-treatment steps depends on the physical properties of the fibrous material stream 12 and one or more of the aforementioned pre-treatment steps may not be required.

The fibrous feedstock 16 is fed into a mixing step 18 where it is mixed with one or more binder reagents 20 to produce an agglomeration mixture 22. If required, water 24 may be added to the mixing step 18. In certain embodiments, the absorbent material may also include one or more of reinforcing fillers 26 and additives 28. It is envisaged that they will also be introduced into the mixing step 18. Once sufficient mixed, the agglomeration mixture 22 is fed into an agglomeration step 30 in the presence of a polymerisation activator 32 to produce agglomerates 34. The agglomerates 34 are directed to a screening step 36 to ensure correct physical specifications. Unsatisfactory agglomerates 38 are returned to the agglomeration step 30 for further processing. Satisfactory agglomerates are then passed to a drying step 40 to remove excess water, resulting in an absorbent material 42 suitable for the absorption of liquids.

### Pre-Treatment

In order to ensure suitability for the process of the present invention, the fibrous material first undergo a pre-treatment step. The pre-treatment step prepares the fibrous material for the further processing and may contain one or more of the following pre-treatment steps; screening, shredding, grinding and dewatering to produce a fibrous feedstock. The required pre-treatment steps depends on the physical properties of the fibrous material and one or more of the aforementioned pre-treatment steps may not be required.

Large particles have been found to interfere with the production of suitable agglomerates and so it is preferred that must either be removed from the fibrous material or undergo a size reduction process. Preferably, the step of pre-treatment of the fibrous material more specifically comprises one of more of: screening; shredding; grinding; or size reduction.

In one form of the present invention, the step of size reduction may more specifically comprise one or more of the following: mechanical size reduction, chemical fibre softening, composting, bacterial pre-treatment, enzyme pre-treatment, resin dissolution, catalyst impregnation, cellulose extraction, cellular desiccation pre-treatment, torrification, delignification and charcoaling.

As would be understood by a person skilled in the art, various treatments can be utilised to soften or reduce fibrous material streams and some have particular large tonnage applications. Composting is a simple method of quickly breaking down biomass fibres into much softer products. One major advantage is the condensation of mass with significant cellular water loss, making the fibres much softer by having less bulk cellular water.

As would be understood by a person skilled in the art desiccation is a drying process which involves the addition of a desiccant to the fibrous material stream to reduce water content in the fibrous material stream. Advantageously, simple raw material desiccation both densifies and conditions the feed, making it much drier and much more brittle for low cost shredding and grinding prior to agglomeration. Desiccation can be carried out naturally or more practically utilising low level pre-treatment with aggressive desiccation prior to shredding and grinding, where the fibrous material are significantly more brittle, densified and require significantly less energy to grind than natural feedstock/tonne.

### Feedstock Combination

The fibrous feedstock is combined with one or more binder reagents to produce an agglomeration mixture. If required, additional water may be added to the agglomeration mixture.

The agglomeration mixture comprises 0.05-1 dry weight % polymerised binder reagents by dry weight of the agglomeration mixture.

In one embodiment, the agglomeration mixture comprises water. In one embodiment, the water content of the agglomeration mixture is between 30% and 80%. The inventors have found that sufficient water need to be included in the agglomeration mixture in order to ensure the feedstock will adhere.

In embodiments where reinforcement fillers are included in the absorbent material, the reinforcement fillers are blended into the agglomeration mixture.

In embodiments where one or more additives are included in the absorbent material, the one or more additive are blended into the agglomeration mixture.

### Seed Particles

In one form of the present invention, method further comprises the addition of a seed particles to the agglomeration mixture. Preferably, the seed particles act as an agglomerate nucleolus with the polymerised binder agents and fibrous material forming a coating around the seed particle. It is envisaged that the seed particle may be a synthetic or natural organic substance. In one form of the present invention, the seed particle is a rubber or plastic.

In an alternative form of the present invention, an active adsorption agent is used as the seed particle. As discussed above, active adsorption agent may be included into the absorbent material to selectively adsorb and retain targeted substances in the liquid being treated. In this form of the present invention, it is envisaged that the active adsorption agent will form the core of the absorbent material.

### Drying Step

In one form of the present invention, the drying step is performed at a temperature of less than 100° C. In an alternative form of the present invention, the drying step is performed at a temperature of less than 90° C. In an alternative form of the present invention, the drying step is performed at a temperature of less than 80° C. In an alternative form of the present invention, the drying step is performed at a temperature of less than 70° C. In an alternative form of the present invention, the drying step is performed at a temperature of less than 60° C. In an alternative form of the present invention, the drying step is performed at a temperature of less than 50° C. In an alternative form of the present invention, the drying step is performed at a temperature of less than 40° C. In an alternative form of the present invention, the drying step is performed at a temperature of less than 30° C. In an alternative form of the present invention, the drying step is performed at ambient temperature.

In preferred form of the invention, the drying period is between 2 to 20 days. Preferably still, the drying period is 7 to 14 days. The inventor has discovered that the drying period should proceed for as until the moisture loss is no longer measurable. In order to determine this, samples of the agglomerates are weighed at regular interval in order to determine when the agglomerates have ceased losing moisture by evaporation. As would be understood by a person skilled in the art, the length of the drying period is highly dependent upon one or more of the following criteria: the ambient humidity and wind velocity of the drying step; the temperature of the drying step; whether the drying step is performed under cover or inside a protective environment; and the diameter of the agglomerates (larger the diameter the slower drying/desiccation).

The present invention further relates to a method of absorbing a liquid, the method comprising the step of contacting the liquid with the absorbent material described above to absorb at least a portion of the liquid into the absorbent material, thereby producing a loaded absorbent material.

As described above, the absorbent material comprises fibrous material that are held into a matrix using one or more polymerized binder reagents. The use of the fibrous material has been found by the inventors to produce a porous matrix with significant void space. When contacted with a liquid, the liquid will be absorbed into this void space and be retained by the absorbent material. Without wishing to be bound by theory, the inventors understand that a substantial portion of the liquid is retained within the polymer matrix through Van der Waals forces and/or surface tension.

The absorbent material has been found to be particularly useful for the recovery of oils. In particular, the absorbent material may be used to recover petroleum oils spills from water sources. The polymer matrix will typically be less dense than water and so the absorbent material will float on top of the water layer, absorbing oils that float on top of the water. The loaded absorbent materials can then be easily collected, effectively removing the oil from the water.

In certain embodiments, the liquid may contain one or more substance entrained therein. Such substances include, but are not limited to, fine solid suspensions, dissolved metal salts, organic compounds such as waste oils, persistent organic pollutant compounds, emulsions, chemical compounds, heavy and radioactive metal salts, antibiotics, water treatment wastes, fire fighting foam liquids and concentrates, industrial wastes, landfill leachates, micro-plastics and agricultural effluents. The inventors have found that at least some of these substances will co-absorbed into the absorbent material matrix with the liquid. This allows for the clean-up of such substances, even when there is a high liquid content and low contaminant concentrations. It is envisaged that this will be particularly useful when cleaning up such substances from waterways, storage ponds and contaminated groundwater aquifers.

As discussed above, one or more additives may be included in the absorbent material. In one embodiment, the additives include active adsorption agents to selectively absorb particular target substances. It is envisaged that these agents will generally have a micro-porous structure that will accommodate certain sized species, particularly charged species. Such agents may be selected from one or more of zeolites, pumice type minerals, activated carbon/char, modified active clays and ion exchange resins.

Alternatively or additionally, the additives may include one or more neutralisation agents. Such neutralisation agents include pH modifiers, chlorinators, bactericides and odour removal agents. Such neutralisation agent have been found to be useful when treating liquids that are acidic, alkaline, infected or rancid/odorous in nature.

In one embodiment, the contact time of the absorbent material and the liquid is at least 5 minutes.

Following the step of contacting the absorbent material with the liquid, the loaded absorbent material may be separated from the remaining liquid and may be directed to a treatment step. The nature of the treatment step will be dependent on the liquid being absorbed. In particularly, the treatment step will depend on the liquid content of the loaded absorbent material.

In one embodiment, the treatment step comprises a chemical treatment step. Preferably, the chemical treatment step will result in the chemical destruction or neutralisation of the absorbed liquid or one or more substances entrained therein.

In one embodiment, the treatment step comprises the recovery of the absorbed liquids from the loaded absorbent material.

In one embodiment, the loaded absorbent material is subjected to a drying step. As discussed above, the inventors understand that liquids will be retained within the polymer matrix by Van der Waals forces. Because of this, it has been found that the energy required for evaporation of the water and other volatile liquids from the loaded absorbent material is quite low. Once the loaded absorbent material is removed from the liquid and exposed to air, water and other volatile compounds will evaporate out of the matrix. The inventors have found that evaporation can be improved by directing a rapid air flow across the surface of the loaded absorbent material. Advantageously, heat is not typically required for evaporation to take place. This aspect of the invention has been found to greatly reduce drying costs. In one form of the present invention, the drying step is conducted in a dedicated drying apparatus. Preferably, the drying apparatus comprises a rotating drum. More preferably, an air flow is directed through the drying apparatus.

It has also been found by the inventors, that as water or other volatile liquids evaporate from the loaded absorbent material, at least a portion of other liquids or entrained substances are retained within the porous matrix. In this manner, contaminants in water sources are efficiently separated from the water. The evaporated water, which is substantially free of contaminants can then be collected and safely disposed of or be reused following appropriate treatment processes. The drying step will result in a final product with a very low water content. The loaded absorbent material may then be subsequently treated to destroy or otherwise neutralise the absorbed materials.

Non-volatile components that will not evaporate under ambient drying conditions (0° C. to 35° C.) will be retained in the matrix of the agglomerate as part of the body of the agglomerate. This characteristic allows the agglomerate to be recycled for adsorbing further contaminated liquids. The absorption and drying steps can be repeated multiple times. As the process is repeated, additional non-volatile components are loaded into the absorbent material. The inventors have found that the absorption/drying process can typically be repeated for three to four cycles for concentrated liquids, oils, emulsions or slurries and upwards of 15 cycles for highly diluted liquids with low concentrations of soluble elements. By repeating the absorption/drying processed through multiple cycles, large volumes of contaminated water may be processed with a comparatively low amount of absorbent material. As the loaded absorbent material may be dried in low energy process, the cost to treat the contaminated water is also reduced.

Following the one or more treatment steps, the loaded absorbent material may be directed to disposal. The choice of disposal method will be dictated by the particular liquid being absorbed and any contaminants entrained therein. It is preferred that the disposal step is conducted after a drying step. The inventors have found that the absorbent material exhibits a very low moisture content when fully dried and this factor enhances long term storage and handling/re-handling of the loaded absorbent materials. Alternatively, the high fibre content and low water content of the loaded absorbent material allow for combustion of the loaded material at high temperatures. This will result in the thermal destruction of combustible materials, whilst allowing non-combustible materials to be collected and disposed of. In one form of the present invention, the temperature of the combustion step is at least 1000° C. Emerging pollutants of concern and “Persistent Organic Pollutants” (POP's) such as the per- and poly-fluoroalkyl substances (PFOS family), PCB's, refrigerants, hormones, anti-biotics and microplastics/electronic wastes are all destroyed by high temperature incineration in an oxidising flame. In this manner, should any of these pollutants be adsorbed by the adsorbent material of the present invention, the combustion step will destroy these pollutants. This avoids the recontamination risks associated with disposing of such materials in landfill or long-term storage facilities.

In one form of the present invention, the loaded absorbent material is suitable for use as a fuel source. Once dried, the loaded absorbents have a very low water content. This has been found by the inventors to allow the loaded absorbents to substitute or supplement coal as fuel source in coal fired power stations. The inventors have found that the hardness of the dried loaded absorbent material make it suitable for use in such power stations.

In another form of the invention, valuable materials can be recovered from low density liquids by preferential absorption of water in the liquid leaving behind the valuable solid portion in a much more concentrated form. Applications include concentration of proteins from dilute vegetable processing effluents, algae from nutrient recovery ponds, densifying liquids for meat rendering instead of heat, and low cost recovery of fibres from vegetable processing and wood pulp processing.

### Example 1

A test was undertaken to determine the effectiveness of the absorbent material of the present invention for the absorption of large volumes of dilute contaminated fluids containing “persistent organic pollutants” (POP's). The test was undertaken using spent firefighting fluids containing PFOS compounds and other hydrocarbons. Liquid waste is spent 6% “Ansulite” AFFF firefighting foam.

The absorbent material tested was produced from a feedstock that comprised 60% reject paper waste pulp and 40% hardwood sawdust by dry weight. Residual agglomerate moisture is 8.2%. The binder reagent used was a styrene monomer at a dosage of 0.3% by dry weight with ammonium persulphate being used as a polymerisation activator at a dosage of 0.05% by dry weight.

The liquid waste was contacted with the absorbent material and was dried over a 5 day period. The dried absorbent material was then again contacted with the liquid waste and again dried for a 5 day period. The results are shown in Tables 1 to 5 below.

TABLE 1
Feed Assay

| | | Wet | Desiccated | Adsorbed |
|---|---|---|---|---|
| Material | Weights g | Weight g | weight (g) | AFFF % |
| Type 1 Agglomerates | 1090 | | | |
| Total dry feed | 1000 | | | |
| 1st Soak liquid used | 2120 | 3120 | | |
| 1st Desiccation | | | 1150 | 13.0% |
| 2nd Soak Liquid used | 2075 | 3325 | | |
| 2nd Desiccation | | | 1290 | 22.4% |
| Total evaporated | 4195 | | | |

TABLE 2
Agglomerate Tested

| Results | Weight g |
|---|---|
| Agglomerates tested | 1000 |
| Fibre losses | nil |
| Agglomerate size range | 15-25 mm |

TABLE 3
Desiccating Conditions
Tray stored open top - still air
No fan ventilation
No air conditioning

TABLE 4
Ambient Conditions during desiccation - Max/Min

| | Max Temp | Min Temp | |
|---|---|---|---|
| Time | (° C.) | (° C.) | Humidity - reported |
| Day | 32 | 25 | 55% to 68% |
| Night | 19 | 17 | 42% to 51% |

TABLE 5
Results

| | | AFFF | Total | % of | |
|---|---|---|---|---|---|
| Day | Weight | Loss (g/d) | AFFF Loss (g) | AFFF | Agglomerate % |
| 0 | 3120 | 0 | | | 32.1% |
| 1 | 2495 | 625 | 625 | 29.5% | 40.1% |
| 2 | 1955 | 540 | 1165 | 54.9% | 51.1% |
| 3 | 1535 | 420 | 1585 | 74.7% | 65.1% |
| 4 | 1204 | 331 | 1916 | 90.4% | 83.1% |
| 5 | 1150 | 54 | 1970 | 92.9% | 86.9% |
| 2nd soaking | | | | | |
| 0 | 3325 | 0 | | | 30.1% |
| 1 | 2695 | 630 | 630 | 30.3% | 37.1% |
| 2 | 2123 | 572 | 1202 | 57.9% | 47.1% |
| 3 | 1683 | 440 | 1642 | 79.1% | 59.4% |
| 4 | 1328 | 355 | 1997 | 96.2% | 75.3% |
| 5 | 1290 | 38 | 2035 | 98.1% | 77.5% |
| | Total | 2035 | | | |

### Example 2

A test was undertaken to determine the effectiveness of the absorbent material of the present invention for the absorption of a high viscosity liquid containing contaminants. The test was undertaken using 100% “Ansulite” AFFF fire fighting concentrate which contains a C8 PFOS active ingredient. This active ingredient is now banned from use and the concentrate was sourced from an oil terminal disposal stockpile.

The absorbent material tested was produced from a feedstock that comprised 60% reject paper waste pulp and 40% hardwood sawdust by dry weight. Residual agglomerate moisture is 8.2%. The binder reagent used was a styrene monomer at a dosage of 0.3% by dry weight with ammonium persulphate being used as a polymerisation activator at a dosage of 0.05% by dry weight.

The liquid waste was contacted with the absorbent material and was dried over a 5 day period. The results are shown in Tables 6 to 10 below.

TABLE 6
Feed Assay

| | | Wet | Desiccated | Residual |
|---|---|---|---|---|
| Material | Weights g | Weight g | weight (g) | AFFF % |
| Type 1 Agglomerates | 1090 | | | |
| Total dry feed | 1000 | | | |
| 1st Soak liquid used | 2032 | 3122 | | |
| 1st Desiccation | | | 1260 | 21% |
| Total evaporated | 1772 | | | |

TABLE 7
Agglomerate Tested

| Results | Weight g |
|---|---|
| Agglomerates tested dry | 1000 |
| Fibre losses | nil |
| Agglomerate size range | 15-25 mm |

TABLE 8
Desiccating Conditions

Tray stored open top - still air
No fan ventilation
No air conditioning

TABLE 9
Ambient Conditions during desiccation - Max/Min

| Time | Max Temp (° C.) | Min Temp (° C.) | Humidity - reported |
|---|---|---|---|
| Day | 32 | 25 | 55% to 68% |
| Night | 19 | 17 | 42% to 51% |

TABLE 10
Results

| Day | Weight | AFFF Loss (g/d) | Total Loss (g) | % of AFFF | Agglomerate % |
|---|---|---|---|---|---|
| 0 | 3122 | | | | |
| 1 | 2650 | 472 | 472 | 23.2% | 41.1% |
| 2 | 2228 | 422 | 894 | 44.0% | 48.9% |
| 3 | 1868 | 360 | 1254 | 61.7% | 58.3% |
| 4 | 1558 | 310 | 1564 | 76.9% | 70.0% |
| 5 | 1350 | 208 | 1772 | 87.2% | 80.7% |

A test was undertaken to determine the effectiveness of the absorbent material of the present invention for the absorption of liquid hydrocarbons on saltwater to simulate an oil tanker spill in the ocean. Liquid waste consisted of waste 20/50 W mineral oil floating on seawater. Oil was 10 mm depth and water 40 mm depth.

The absorbent material tested was produced from a feedstock that comprised 70% pine sawdust and 30% reject paper waste pulp by dry weight. Residual agglomerate moisture is 7.5%. The binder reagent used was a styrene monomer at a dosage of 0.3% by dry weight with ammonium persulphate being used as a polymerisation activator at a dosage of 0.05% by dry weight

The liquid waste was contacted with the absorbent material and was dried over a 5 day period. The results are shown in Tables 11 to 15 below.

TABLE 11
Feed Assay

| Data for | Dry | Wet |
|---|---|---|
| Run #3 | Weight g | Weight g |
| Agglomerates | 1075 | |
| Dry matter | 1000 | |
| Waste oil | | 2000 |
| Seawater | | 8000 |
| Soaked agglomerates | | 3260 |
| Desiccated agglomerates | | 3023 |
| Residual oil | | 52 |

TABLE 12
Agglomerate Tested

| Results | Weight g |
|---|---|
| Agglomerates tested dry | 1000 |
| Fibre losses | nil |
| Agglomerate size range | 15-25 mm |

TABLE 13
Desiccating Conditions

Tray stored open top - still air
No fan ventilation
No air conditioning

TABLE 14
Ambient Conditions during desiccation - Max/Min

| Time | Max Temp (° C.) | Min Temp (° C.) | Humidity - reported |
|---|---|---|---|
| Day | 28 | 26 | 55% to 62% |
| Night | 19 | 18 | 45% to 51% |

TABLE 15
Results

| Desiccation | | Moisture | Cumulative |
|---|---|---|---|
| Day | Weight | Loss (g/d) | loss g |
| 0 | 3260 | | |
| 1 | 3205 | 55 | 55 |
| 2 | 3160 | 45 | 100 |
| 3 | 3102 | 58 | 158 |
| 4 | 3060 | 42 | 200 |
| 5 | 3023 | 37 | 237 |

### Example 4

A test was undertaken to determine the effectiveness of the absorbent material of the present invention for the absorption of waste consumer liquids. Liquid waste is 50% milk and 50% fruit juice.

The absorbent material tested was produced from a feedstock that comprised 60% reject paper waste pulp and 40% hardwood sawdust by dry weight. Residual agglomerate moisture is 7.9%. The binder reagent used was a styrene monomer at a dosage of 0.3% by dry weight with ammonium persulphate being used as a polymerisation activator at a dosage of 0.05% by dry weight

The liquid waste was contacted with the absorbent material and was dried over a 5 day period. The dried absorbent material was then again contacted with the liquid waste and again dried for a 5 day period. The final desiccated agglomerate moisture 8.1%. The results are shown in Tables 16 and 17 below:

TABLE 16
Feed Assay

| | | Wet | Desiccated | Adsorbed | Adsorbed |
|---|---|---|---|---|---|
| Material | Weights g | Weight g | weight (g) | solids g | solids % |
| Type 1 Agglomerates | 1079 | | | | |
| Total dry feed | 1000 | | | | |
| 1st Soak liguid used | 2176 | 3250 | | | |
| 1st Desiccation | | | 1185 | | |
| 2nd Soak Liguid used | 2140 | | | | |
| 2nd Desiccation | | 3325 | 1342 | 109 | 8.1% |
| Total liguid used | 4316 | | | | |
| Total evaporated | 4205 | | | | |
| Final Agglomerate | 1342 | | | | |
| mass | | | | | |
| Final Dry weight | 1233.3 | Drying @60 C. for 24 hrs | | | |
| Final solids % | 91.90% | | | | |
| Final Moisture % | 8.10% | | | | |

TABLE 17
Results

| | | Moisture Loss | Total moisture |
|---|---|---|---|
| | Weight | (g/d) | loss (g) |
| Days after | | | |
| 1^{st} soaking | | | |
| 0 | 3250 | 0 | |
| 1 | 2647 | 603 | 603 |
| 2 | 2159 | 488 | 1091 |
| 3 | 1754 | 405 | 1496 |
| 4 | 1434 | 320 | 1816 |
| 5 | 1185 | 249 | 2065 |
| Days after | | | |
| 2^{nd} soaking | | | |
| 0 | 3325 | 0 | |
| 1 | 2800 | 575 | 575 |
| 2 | 2349 | 507 | 1082 |
| 3 | 1925 | 446 | 1528 |
| 4 | 1539 | 415 | 1943 |
| 5 | 1342 | 197 | 2140 |
| | | Total Loss | 4205 |

### Example 5

A test was undertaken to determine the effectiveness of the absorbent material of the present invention for the removal of water from dilute waste effluents to concentrate valuable solids contained in the waste stream. Liquid waste is 2% solids vegetable process effluent

The absorbent material tested was produced from a feedstock that comprised 60% reject paper waste pulp and 40% hardwood sawdust by dry weight. Residual agglomerate moisture is 7.7%. The binder reagent used was a styrene monomer at a dosage of 0.3% by dry weight with ammonium persulphate being used as a polymerisation activator at a dosage of 0.05% by dry weight

The liquid waste was contacted with the absorbent material and was dried over a 5 day period. The loading and drying was repeated for a total of 4 contacts. The results are shown in the tables 18 and 19 below:

TABLE 18
Feed Assay

| | Weight | Moisture Loss (g/d) | Total moisture loss (g) |
|---|---|---|---|
| Days after | | | |
| 1^{st} soaking | | | |
| 0 | 3297 | 0 | |
| 1 | 2714 | 583 | 583 |
| 2 | 2278 | 436 | 1019 |
| 3 | 1876 | 402 | 1421 |
| 4 | 1466 | 410 | 1831 |
| 5 | 1090 | 376 | 2207 |
| liquid absorbed | 2220 | | |
| Days after | | | |
| 2^{nd} soaking | | | |
| 0 | 3330 | 0 | |
| 1 | 2872 | 575 | 575 |
| 2 | 2218 | 507 | 1082 |
| 3 | 1940 | 446 | 1528 |
| 4 | 1601 | 415 | 1943 |
| 5 | 1380 | 221 | 2164 |
| Liquid absorbed | 2240 | | |
| Days after | | | |
| 3^{rd} soaking | | | |
| 0 | 3406 | 0 | |
| 1 | 2625 | 781 | 781 |
| 2 | 2106 | 519 | 1300 |
| 3 | 1769 | 337 | 1637 |
| 4 | 1488 | 281 | 1918 |
| 5 | 1197 | 291 | 2209 |
| Liquid absorbed | 2026 | | |
| Days after | | | |
| 4^{th} soaking | | | |
| 0 | 3412 | 0 | |
| 1 | 2669 | 575 | 575 |
| 2 | 2370 | 507 | 1082 |
| 3 | 1968 | 446 | 1528 |
| 4 | 1566 | 415 | 1943 |
| 5 | 1387 | 179 | 2122 |
| Liquid absorbed | 2215 | | |
| | | Cumulative liquid | 8701 |
| | | absorbed | |

TABLE 19
Results

| | |
|---|---|
| Vegetable waste effluent g | 10000 |
| Solids content g | 200 |
| Residual liquids g | 1299 |
| Residual solids content % | 15.40% |

The results demonstrate that the dilute liquid waste may be concentrated.

### Example 6

A series of trials were undertaken to determine the effectiveness of the absorbent material of the present invention for the absorption of a high viscosity liquid containing contaminants and to determine whether dilution of the high viscosity liquid improved absorption. Tests were undertaken on samples of 100% “Ansulite” AFFF firefighting foam concentrates using two different absorbent materials. Simultaneous trials were also undertaken on samples of “Ansulite” AFFF firefighting foam concentrates that had been diluted to 6% with water.

The absorbent materials tested was produced from a feedstock that comprised either 100% reject paper waste pulp or 60% reject paper waste pulp and 40% hardwood sawdust by dry weight. Residual agglomerate moisture is 7.7%. The binder reagent used was a styrene monomer at a dosage of 0.3% by dry weight with ammonium persulphate being used as a polymerisation activator at a dosage of 0.05% by dry weight

The absorbent materials were placed in separate reaction vessels and the contaminant liquids were added to the vessel. The vessels were left open to allow the evaporation of water and volatiles. Details of each trial are shown in Table 20:

TABLE 20
Starting Results

| | | | Day 0 | | |
|---|---|---|---|---|---|
| | | | | Contaminant | Water |
| | Absorbent | | Pellets | added | added |
| Trial | Material | Contaminated Liquid | (grams) | (grams) | (grams) |
| A | Paper waste | 100% Anusulite Foam | 250 | 508 | 0 |
| | Pellets | concentrate | | | |
| B | Paper/wood | 100% Anusulite Foam | 250 | 509 | 0 |
| | waste pellets | concentrate | | | |
| C | Paper waste | 6% Ansulite Foam solution | 250 | 30 | 470 |
| | Pellets | in water | | | |
| D | Paper/wood | 6% Ansulite Foam solution | 250 | 30 | 470 |
| | waste pellets | in water | | | |

The vessels were allowed to stand for 14 days and the pellets were weighed to estimate quantity of retained mass. All pellet samples were dry with slight semi solid smear of concentrate remaining on the bottom of vessels A and B. All pellets appeared to be mechanically robust. The pellets of vessels A and B were physically tacky on the outside surface. The pellets of vessels C+D were completely dry on the outside. Additional contaminant liquid and/or water was then added to the vessels. The results are shown in Table 21.

TABLE 21
Day 14 Results

| | | Pellets | Increase | Mass lost | Contam- | |
|---|---|---|---|---|---|---|
| | Pellets | weight | in pellets | to | inant | Water |
| | weight | increase | weight | evaporation | added | added |
| Trial | (grams) | (grams) | % | (grams) | (grams) | (grams) |
| A | 315 | 65 | 26 | 443 | 0 | 500 |
| B | 326 | 76 | 30.4 | 433 | 0 | 500 |
| C | 267 | 17 | 6.8 | 483 | 30 | 470 |
| D | 255 | 5 | 2 | 495 | 30 | 470 |

The vessels were allowed to stand for a further 14 days and the pellets were again weighed and additional contaminates were added. The results are shown in Table 22.

TABLE 22
Day 28 Results

| | | Pellets | Increase in | Mass lost | Concen- | |
|---|---|---|---|---|---|---|
| | Pellets | weight | pellets | to | trate | Water |
| | weight | increase | weight | evaporation | added | added |
| Trial | (grams) | (grams) | % | (grams) | (grams) | (grams) |
| A | 330 | 15 | 6 | 485 | 250 | 250 |
| B | 342 | 16 | 6.4 | 484 | 250 | 250 |
| C | 302 | 35 | 14 | 465 | 30 | 470 |
| D | 275 | 20 | 8 | 480 | 30 | 470 |

The vessels were allowed to stand for a further 13 days and the pellets were weighed. No liquid was present at the bottom of any of the vessels. All pellets were found to be dry and mechanically robust with only some dry residue present on the bottom of the vessels. Mechanical damage was observed to some pellets in vessels A and B. The results of the trial are shown in Table 23:

TABLE 23
Day 41 Results

| | | | Increase | |
|---|---|---|---|---|
| | | Pellets | in | Mass lost |
| | Pellets | weight | pellets | to |
| | weight | increase | weight | evaporation |
| Trial | (grams) | (grams) | % | (grams) |
| A | 400 | 70 | 28 | 180 |
| B | 412 | 70 | 28 | 180 |
| C | 327 | 25 | 10 | 475 |
| D | 298 | 23 | 9.2 | 477 |

The results showed that the absorbent material of the present invention was suitable for the absorption of the viscous contaminated liquids. It was also shown that the dilution of such liquids may be helpful in improving the mechanical properties of loaded absorbent material.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

The present invention is not to be limited in scope by any of the specific embodiments described herein. These embodiments are intended for the purpose of exemplification only. Functionally equivalent products, formulations and methods are clearly within the scope of the invention as described herein.

The invention described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

1. An absorbent material, the absorbent material comprising:
a matrix formed from a fibrous material and one or more polymerised binder reagents.

2. An absorbent material according to claim 1, wherein the absorbent material comprises 0.05-5 dry weight % polymerised binder reagents.

3. An absorbent material according to claim 1, wherein the absorbent material comprises a polymerisation activator.

4. An absorbent material according to claim 3, wherein the absorbent material comprises 0.005-0.5 dry weight % polymerisation activator.

5. An absorbent material according to claim 1, wherein the fibrous material comprises cellulosic fibres or synthetic fibres.

6. (canceled)

7. An absorbent material according to claim 1, wherein the absorbent material comprises 10-99.5 weight % fibrous material.

8. An absorbent material according to claim 1, wherein the absorbent material comprises 30-60 weight % fibrous material.

9. An absorbent material according to claim 1, wherein the absorbent material comprises a reinforcing filler.

10. An absorbent material according to claim 9, wherein the reinforcing filler is a solid particulate material.

11. An absorbent material according to claim 9, wherein the absorbent material comprises 40-70 dry weight % reinforcing fillers.

12. An absorbent material according to claim 1, wherein the absorbent material comprises active adsorption agents.

13. An absorbent material according to claim 1, wherein the absorbent material is formed into agglomerates or wherein the absorbent material is formed into pellets.

14. (canceled)

15. A method for producing an absorbent material, the method comprising the steps of:
combining a feedstock comprising fibrous material with one or more binder reagents; and
introducing the feedstock into an agglomeration apparatus in the presence of a polymerisation activator to produce the absorbent material.

16. A method according to claim 15, wherein the binder reagents are selected from one or more of styrene monomer compounds, vinyl monomer compounds or silicon monomer compounds.

17. A method according to claim 15, wherein the agglomeration mixture comprises between 10-99.5 weight % fibrous material.

18. A method of absorbing a liquid, the method comprising the step of contacting the liquid with the absorbent material of claim 1 to absorb at least a portion of the liquid into the absorbent material to produce a loaded absorbent material

19. A method according to claim 18, wherein at least a portion of entrained particles or dissolved substances within the liquid is absorbed by the absorbent material

20. A method according to claim 18, wherein the loaded absorbent material is directed to one or more treatment steps.

21. A method according to claim 18, wherein the loaded absorbent material is subjected to a drying step.

22. A method according to claim 18, wherein the loaded absorbent material is directed to disposal.

23. A method according to claim 20, wherein the loaded absorbent material is be subjected to a high temperature treatment step to destroy combustible materials.
